(19) United States
(12) Patent Application Publication
(10) Pub. No.: US 2007/0285713 A1
(43) Pub. Date: Dec. 13, 2007

(54) PRINTER SYSTEM AND CONTROL METHOD THEREOF

(75) Inventors: Satoru YAMAMOTO, Abiko-shi (JP); Hiroshi MATSUMOTO, Toride-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/762,326

(22) Filed: Jun. 13, 2007

(30) Foreign Application Priority Data
Jun. 13, 2006 (JP) 2006-163861

(51) Int. Cl. G06F 3/12

(52) U.S. Cl. 358/1.15

(57) ABSTRACT

A printer system capable of reducing wasteful power consumption by apparatuses forming the printer system and preventing the service lives of the apparatuses from being shortened and capable of optimizing the capacity of power source. When power of the apparatuses of the printer system is on, a slave controller of each apparatus calculates a preparatory operation time of the apparatus, and transmits the calculated preparatory operation time to a master controller. Based on preparatory operation times indicated by data received from the slave controllers, the master controller determines start-up commencement times (start-up timings) of the slave controllers, and requests (instructs) the slave controllers to start operations upon elapsed of the determined start-up commencement times. In response to received operation start requests, the slave controllers start preparatory operations.

### BACKGROUND OF THE INVENTION

1. Field of the Invention

The present invention relates to a printer system including an image forming apparatus such as an electrophotographic printer and a plurality of sheet processing apparatuses such as finishers connected to the image forming apparatus via communication means, and relates to a control method of the printer system. More specifically, the present invention relates to a method for determining a start-up sequence in which apparatuses in the printer system are started.

2. Description of the Related Art

As shown by way of example in FIG. 1, a printer system is comprised of apparatuses such as a printer 10 for forming an image on a sheet, a plurality of sheet feed decks (first and second sheet feeders 11, 12) for feeding sheets to the printer 10, a stacker 13 for stacking thereon sheets discharged from the printer 10, and a stapler 14 for stapling sheets discharged from the stacker 13. These apparatuses forming the printer system 1 in FIG. 1 include controllers (controllers 50 to 54) connected for communication via a network 5 to one another.

As a control method for such a printer system, a master-slave method has conventionally been known in which an arbitrary one of a plurality of controllers is used as a master controller adapted to concentratedly control the remaining controllers as slave controllers. Since the master controller is capable of communicating with the slave controllers using a predetermined protocol, it is easy to add and alter apparatuses provided that they include protocol-compatible communication means. For example, as shown in FIG. 2, a printer system 2 in which a glue apparatus 15 is used instead of the stapler 14 can easily be constructed.

The apparatuses incorporated in the above described printer system each include a number of loads such as motors. If a plurality of loads are simultaneously started upon start of, e.g., a printer job, a problem is caused that the capacity of power source is deficient compared with a large electric current required for the starting operation. To obviate this, in a known method, loads are caused to start at different timings spaced apart by a predetermined time (Japanese Laid-open Patent Publication No. 2000-289883, for example).

However, the conventional start-up sequence for the apparatuses, which is fixedly determined, cannot be changed with flexibility in modifying the printer system 1 shown in FIG. 1 into the printer 2 shown in FIG. 2, which poses a problem. For example, if preparation times required for the stapler 14 and the stacker 13 to complete their startup are 20 seconds and 10 seconds, then it is efficient in the printer system 1 to start a preparatory operation of the stacker 13 upon elapse of 10 seconds from the start-up of the stapler 14. In the printer system 2, on the other hand, the stacker 13 runs idle for 50 seconds, if the glue apparatus 15 requires 60 seconds to complete its start-up. As described above, if the start-up sequence and start-up timings are fixed, electric power can be consumed wastefully and the service lives of apparatuses can be shortened.

### SUMMARY OF THE INVENTION

The present invention provides a printer system and a control method thereof that are capable of reducing wasteful power consumption by apparatuses forming the printer system and preventing the service lives of the apparatuses from being shortened and capable of optimizing the capacity of power source.

According to a first aspect of the present invention, there is provided a printer system comprising a master apparatus including an image forming apparatus, and at least two slave apparatuses connected for communication to the master apparatus via a network, wherein the master apparatus includes a reception unit adapted to receive, from the at least two slave apparatuses, data indicating preparatory operation times required for the slave apparatuses to complete preparatory operations, and an instruction unit adapted to give the slave apparatuses instructions to cause the slave apparatuses to start the operations based on the preparatory operation times indicated by the received data.

According to the first aspect of the present invention, the master apparatus receives, from the at least two slave apparatuses, data indicating preparatory operation times required for the slave apparatuses to complete their preparatory operations, and based on preparatory operation times indicated by the received data, gives the at least two slave apparatuses instructions to cause them to start their operations. This makes it possible to reduce wasteful power consumption by the apparatuses forming the printer system, prevent the service lives of the apparatuses from being shortened, and optimize the capacity of power source.

According to a second aspect of the present invention, there is provided a printer system comprising a master apparatus including an image forming apparatus, and at least two slave apparatuses connected for communication with the master apparatus via a network, wherein the master apparatus includes a request unit adapted to request the at least two slave apparatuses to send data indicating preparatory operation times required for the slave apparatuses to complete preparatory operations, a reception unit adapted to receive the data indicating the preparatory operation times from the at least two slave apparatuses, and an instruction unit adapted to give the slave apparatuses instructions to cause the slave apparatuses to start the operations based on the preparatory operation times indicated by the received data.

According to the second aspect of the present invention, the master apparatus requests the at least two slave apparatuses to send data indicating preparatory operation times required for the slave apparatuses to complete their preparatory operations, receives the preparatory operation time data from the at least two slave apparatuses, and gives the at least two slave apparatuses instructions to cause them to start their operations based on the received preparatory operation time data. This makes it possible to reduce wasteful power consumption by the apparatuses forming the printer system, prevent the service lives of the apparatuses from being shortened, and optimize the capacity of power source.

According to a third aspect of the present invention, there is provided a printer system comprising a master apparatus including an image forming apparatus, and at least two slave apparatuses connected for communication to the master apparatus via a network, wherein each of the at least two slave apparatuses includes a calculation unit adapted to calculate a preparatory operation time required for the slave apparatus to complete a preparatory operation thereof, and a transmission unit adapted to transmit data indicating the calculated preparatory operation time to the master apparatus, and wherein the master apparatus includes an instruction unit to give the at least two slave apparatuses instructions to cause the slave apparatuses to start the operations based on preparatory operation times indicated by the data received from the slave apparatuses.

According to the third aspect of the present invention, at least two slave apparatuses calculate preparatory operation times required for the slave apparatuses to complete their preparatory operations, and transmit data indicating the calculated preparatory operation times to the master apparatus. The master apparatus gives the at least two slave apparatuses instructions to cause the slave apparatuses to start the operations based on the preparatory operation time data received from the slave apparatuses. This makes it possible to reduce wasteful power consumption by the apparatuses forming the printer system, prevent the service lives of the apparatuses from being shortened, and optimize the capacity of power source. It is also easy for the printer system to cope with addition or alteration of apparatuses forming the printer system.

According to a fourth aspect of the present invention, there is provided a printer system comprising a master apparatus including an image forming apparatus, and at least two slave apparatuses connected for communication to the master apparatus via a network, wherein the master apparatus includes a first instruction unit adapted to give the slave apparatuses instructions to cause the slave apparatuses to start operations, a reception unit adapted to receive responses indicating completions of preparatory operations from the at least two slave apparatuses, a time measurement unit adapted to measure times from when the at least two slave apparatuses are given the instructions to cause the slave apparatuses to start the operations to when the responses are received, and a second instruction unit to give the slave apparatuses instructions to cause the slave apparatuses to start the operations based on the measured times.

According to the fourth aspect of the present invention, the master apparatus gives the at least two slave apparatuses instructions to cause the slave apparatuses to start operations, receives responses indicating the completion of preparatory operations from the at least two slave apparatuses, measures the times from when the instructions to cause the slave apparatuses to start the operations are given to when the responses are received, and gives the at least two slave apparatuses instructions to cause the slave apparatuses to start the operations based on the measured times. This makes it possible to reduce wasteful power consumption by the apparatuses forming the printer system, prevent the service lives of the apparatuses from being shortened, and optimize the capacity of power source. It is also easy for the printer system to cope with addition or alteration of apparatuses forming the printer system.

According to fifth to eighth aspects of the present invention, there are provided control methods of respective ones of the printer systems according to the first to fourth aspects of the present invention.

Further features of the present invention will become apparent from the following description of exemplary embodiments with reference to the attached drawings.

### BRIEF DESCRIPTION OF THE DRAWINGS

FIG. 1 is a block diagram exemplarily showing the construction of a printer system according to a first embodiment of the present invention;

FIG. 2 is a block diagram showing an example of the arrangement in which part of the construction of the printer system in FIG. 1 is modified;

FIG. 3 is a sequence chart exemplarily showing communication between a master controller and slave controllers in the printer system in FIG. 1;

FIG. 4 is a state chart of the master controller shown in FIG. 3;

FIG. 5 is a flowchart showing a preparatory operation time response receiving process (A2) appearing in FIG. 4;

FIG. 6 is a flowchart showing an operation start request transmission process (A3) appearing in FIG. 4;

FIG. 7 is a flowchart showing the details of a timing table creation process (S30 in FIG. 6);

FIG. 8 is a state chart of the slave controller appearing in FIG. 3;

FIG. 9 is a flowchart showing a preparatory operation time response transmission process appearing in FIG. 8;

FIG. 10 is a sequence chart exemplarily showing communication between a master controller and a plurality of slave controllers in a printer system according to a second embodiment;

FIG. 11 is a state chart of the master controller appearing in FIG. 10;

FIG. 12 is a state chart of the slave controller appearing in FIG. 10;

FIG. 13 is a sequence chart exemplarily showing communication between a master controller and a plurality of slave controllers in a printer system according to a third embodiment;

FIG. 14 is a state chart of the master controller appearing in FIG. 13;

FIG. 15 is a flowchart showing an operation start request transmission process appearing in FIG. 14;

FIG. 16 is a flowchart showing the details of a timing table creation process appearing in FIG. 15;

FIG. 17 is a state chart of the slave controller appearing in FIG. 13; and

FIG. 18 is a flowchart showing an operation start request reception process appearing in FIG. 17.

### DETAILED DESCRIPTION OF THE PREFERRED EMBODIMENTS

The present invention will now be described in detail below with reference to the drawings showing preferred embodiments thereof.

### First Embodiment

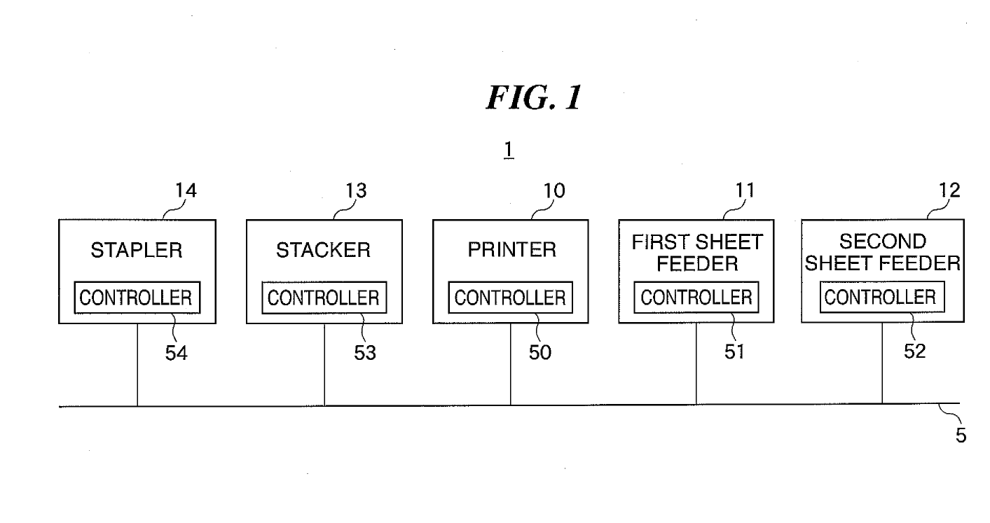

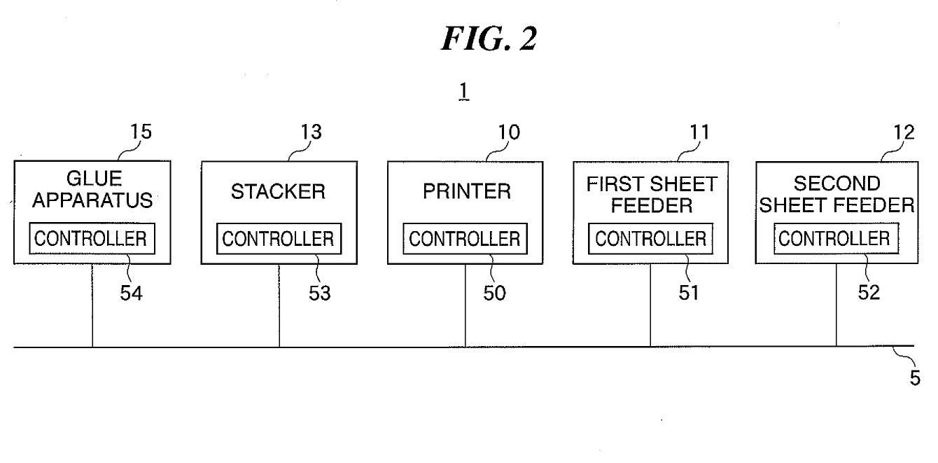

FIG. 1 is a block diagram exemplarily showing the construction of a printer system according to a first embodiment of the present invention, and FIG. 2 is a block diagram showing an example of the arrangement in which part of the construction of the printer system in FIG. 1 is modified.

Referring to FIG. 1, a printer system 1 is comprised of a printer 10 (image forming apparatus) that forms an image on a sheet, a plurality of sheet feeding decks (first and second sheet feeders 11 and 12) from which various sheets are fed to the printer 10, a stacker 13 on which sheets discharged from the printer 10 are stacked, and a stapler 14 that staples sheets discharged from a sheet discharge mechanism of the stacker 13.

On the other hand, a printer system 2 has a glue apparatus 15 instead of the stapler 14 of the printer system 1 shown in FIG. 1.

The apparatuses of the printer system 1 and the glue apparatus 15 comprise, as control means, controllers (controllers 50 to 55) that control the apparatuses and the glue apparatus and are connected to one another via a network 5. Each controller includes communication means and performs communication using a protocol such as CAN (controller area network), ARCNET (Attached resource computer network), Ethernet®, or the like. It should be noted that the protocol is not limited to these.

One of the controllers acts as a master controller and the remaining controllers act as slave controllers.

In this embodiment, an arrangement is described in which the controller 50 in the printer 10 acts as the master controller, and the other controllers 51 to 55 of the first sheet feeder 11, second sheet feeder 12, stacker 13, stapler 14, and glue apparatus 15 act as the slave controllers. It should be noted that a controller acting as the master controller may be fixedly determined in advance or may be dynamically changed to a desired one of the controllers.

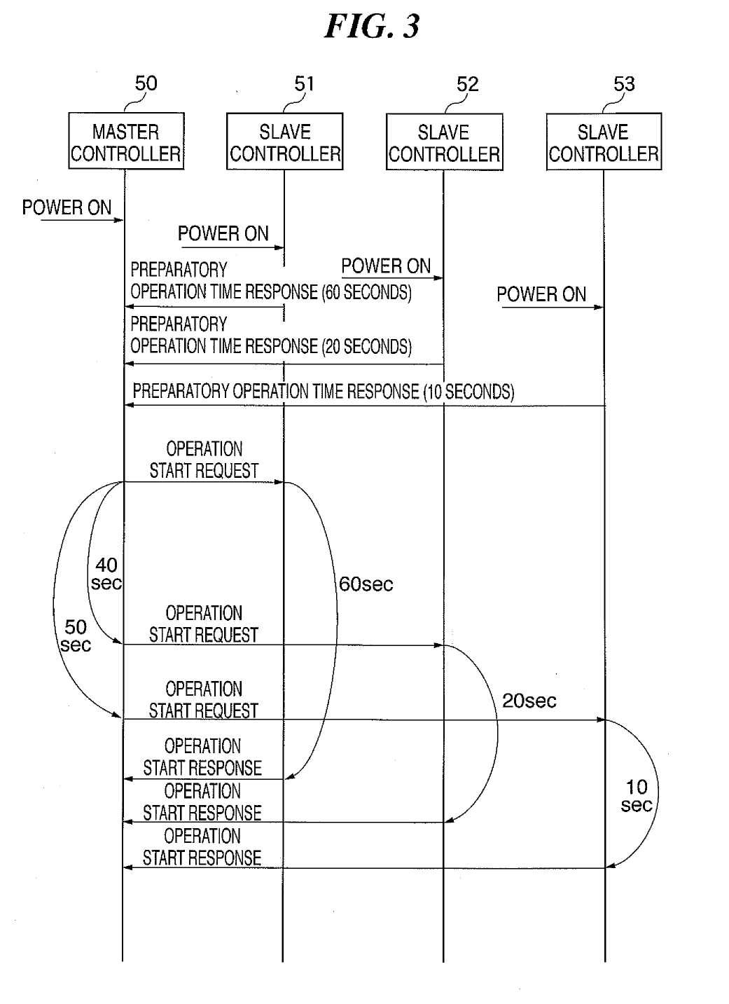

FIG. 3 is a sequence chart exemplarily showing communication between the master controller and the slave controllers in the printer system in FIG. 1. It should be noted that FIG. 3 shows a case where the stapler 14 in the printer system 1 is not used.

In FIG. 3, when electric power of the apparatuses is turned on (at the time of power on) by operating power switches, an operating panel, or the like, none of which is shown, each of the slave controllers 51 to 53 starts calculating a preparatory operation time required for the apparatus concerned to complete its preparatory operation. The preparatory operation time is calculated based on a load arrangement in the apparatus. For example, a finisher apparatus (not shown) having multi-stage trays requires a preparatory operation time of about 10 seconds for tray movement. The glue apparatus 15 sometimes requires a time of about 60 seconds to melt the glue. Upon completion of the calculation of the preparatory operation time, each of the slave controllers 51 to 53 transmits, as a preparatory operation time response, data indicating the calculated preparatory operation time to the master controller 50.

When having received preparatory operation time responses from the slave controllers 51 to 53, the master controller 50 performs a back calculation based on the longest preparatory operation time among the preparatory operation times indicated by the received data to create a timing table for use for giving instructions to specify timings of starting operations of the slave controllers, and stores the timing table into a RAM, not shown, of the master controller 50. An example of the created timing table is shown in the following Table 1.

TABLE 1

| Seq ID | Apparatus ID | Start-up Commencement Time (sec) |
|---|---|---|
| 1 | 51 | 0 |
| 2 | 52 | 40 |
| 3 | 50 | 45 |
| 4 | 53 | 50 |

In table 1, the Seq IDs are IDs indicating the order in which the master controller 50 transmits operation start requests to respective ones of the slave controller 51 to 53, and the apparatus ID is an ID for use for uniquely identifying each of the controllers connected to the network 5. For example, in a case where the preparatory operation times of the slave controllers 51 to 53 (having the apparatus IDs of 51 to 53) are respectively equal to 60 seconds, 20 seconds, and 10 seconds, then the timing table is created such as to permit all the apparatuses to complete their start-up processes upon elapse of the preparatory operation time of the slave controller 51, which is 60 seconds and is the longest among the preparatory operation times. Specifically, the master controller 50 determines start-up commencement times (start timings) of the slave controllers 52, 53 so as to be 40 seconds behind and 50 seconds behind the referenced start-up commencement time of the slave controller 51. It should be noted that the controller 50 may calculate its own preparatory operation time and stores the calculated time in the timing table in a case where the master controller 50 (having the apparatus ID of 50) is required to start itself.

When the timing table has been created, the master controller 50 sequentially transmits operation start requests to the slave controllers 51 to 53 with time differences determined based on the timing table. Specifically, the master controller 50 transmits the operation start request to the slave controller 52 upon elapse of 40 seconds after the operation start request is transmitted to the slave controller 51, and then transmits the operation start request to the slave controller 53 after elapse of further 10 seconds (upon elapse of 50 seconds after the operation start request is transmitted to the slave controller 51).

When receiving the operation start request, each of the slave controllers 51 to 53 causes the apparatus concerned to start a preparatory operation. When the preparatory operation is completed (upon completion of start-up), each of the slave controllers 51 to 53 transmits an operation start response to the master controller 50. The start-up completion timing of the entire printer system is made coincident with that of the controller which is the longest in preparatory operation time (the controller 51 in this embodiment), and when such timing is reached, the start-up of all the apparatuses is completed.

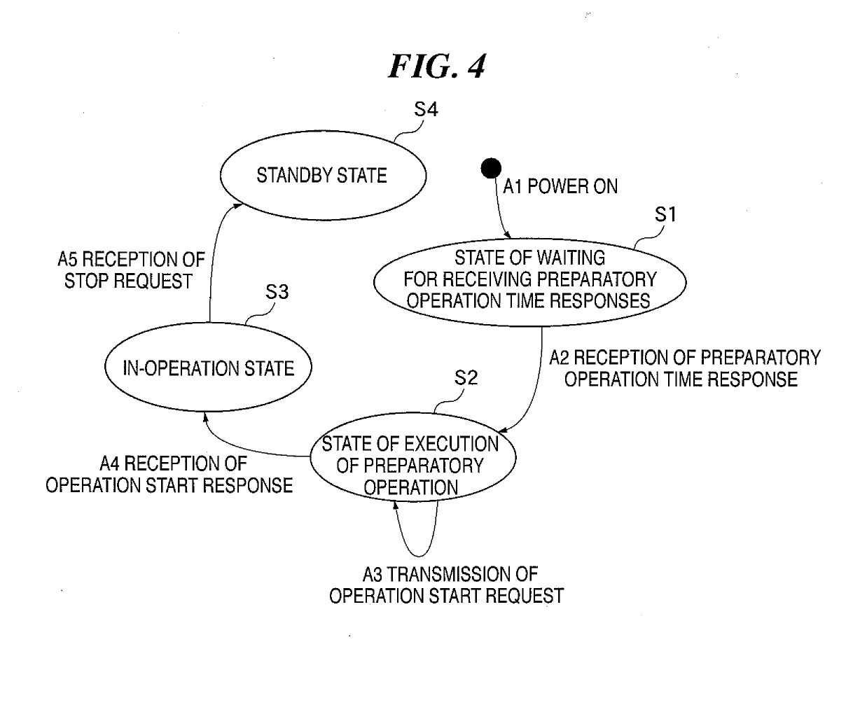

FIG. 4 is a state chart of the master controller 50 shown in FIG. 3.

Referring to FIG. 4, the master controller 50 transmits to a state (S1) of waiting for receiving preparatory operation time responses when electric power is turned ON (A1) Upon reception of the preparatory operation time responses (preparatory operation time data) from the slave controllers 51 to 53 (A2), the master controller 50 transmits to a state (S2) of execution of preparatory operation.

In the preparatory operation execution state (S2), the master controller 50 creates the timing table based on preparatory operation times indicated by the received data, and transmits operation start requests to the apparatuses in sequence from the apparatus indicated at the top of the timing table (in Table 1, the first sheet feeder 11 having the apparatus ID of 51) (A3).

Next, the master controller 50 transmits to an in-operation state (S3) when having received operation start responses from the slave controllers 51 to 53 (A4). In the in-operation state (S3), the master controller 50 causes the slave controllers 51 to 53 to stop operating upon reception of a stop request (A5), whereupon the master controller transmits to a standby state (S4).

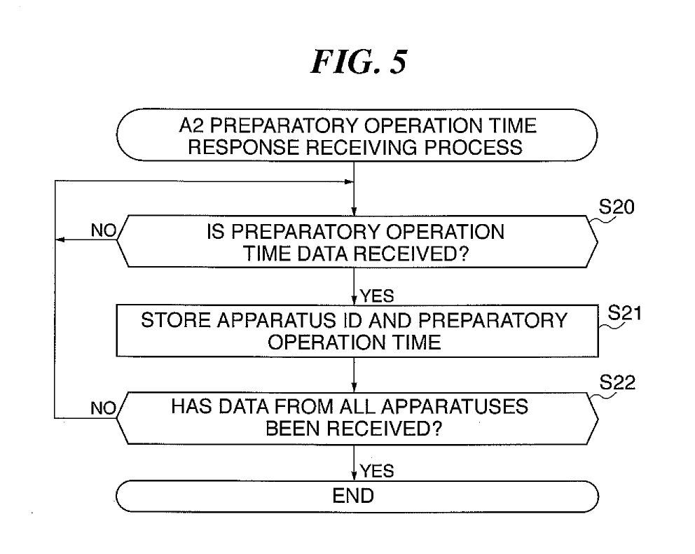

FIG. 5 is a flowchart showing a process (A2) for receiving preparatory operation time responses appearing in FIG. 4. This process is executed by the master controller 50 based on a program read out from a ROM or the like, not shown.

As shown in FIG. 5, the master controller 50 waits for receiving data indicating a preparatory operation time, as a preparatory operation time response, from any one of the slave controllers 51 to 53 (Step S20). When receiving data (YES to the step S20), the master controller 50 causes a built-in RAM, not shown, to store a preparatory operation time indicated by the received data and an apparatus ID of an apparatus corresponding to the preparatory operation time (step S21). The master controller repeatedly carries out the processing in the steps S21 and S22 until having received data representing preparatory operation times from all the slave controllers 51 to 53, and terminates the present process when all the data has been received (YES to the step S22).

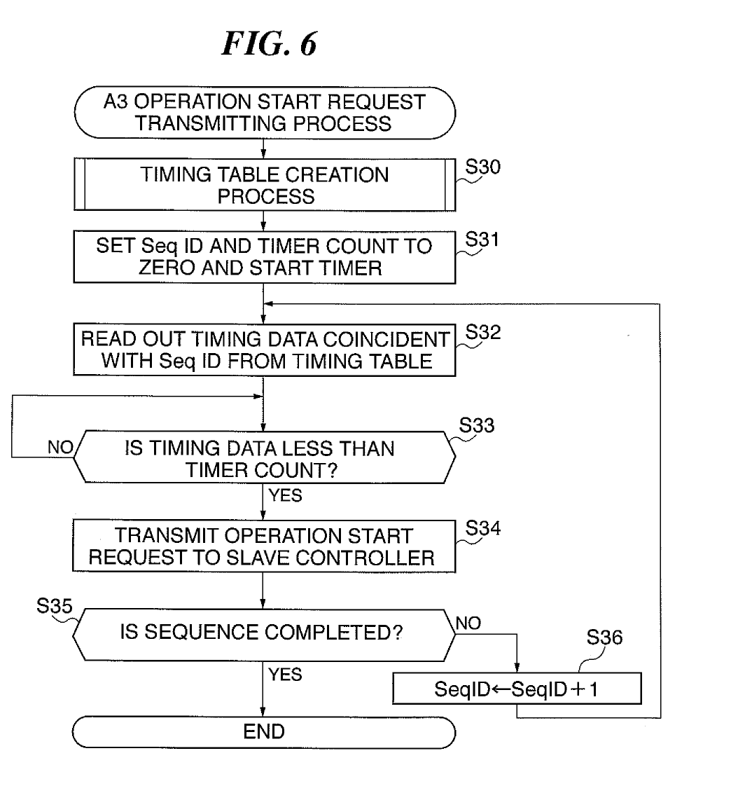

FIG. 6 is a flowchart showing a process (A3) for transmitting operation start requests appearing in FIG. 4. This process is executed by the master controller 50 based on a program read out from a ROM or the like, not shown.

As shown in FIG. 6, the master controller 50 carries out a process for creating a timing table based on preparatory operation times indicated by the data received from the slave controllers 51 to 53 in the preparatory operation time data reception process (A2) (step S30). Next, the master controller initializes to zero a value of a variable “Seq ID” with which the timing table is referred to, initializes a count value of a timer to zero, and causes the timer to start counting (step S31).

Next, the master controller reads out from the timing table created in the step S30 timing data (start-up commencement time) coincident with the value of the variable “Seq ID” (step S32), and waits until the timer count value exceeds the timing data (step S33).

When the timer count value exceeds the timing data (YES to the step S33), the master controller transmits an operation start request to a corresponding slave controller having an apparatus ID corresponding to the timing data (step S34).

When the next timing data is not present in the timing table (YES to step S35), the process is terminated. On the other hand, when the next timing data is present in the timing table (NO to the step S35), the value of the variable “Seq ID” is incremented by one (step S36), and the process returns to the step S32. It should be noted that the process proceeds to the step S36 with the steps S32 to S35 skipped when the variable “Seq ID” has a value thereof equal to zero.

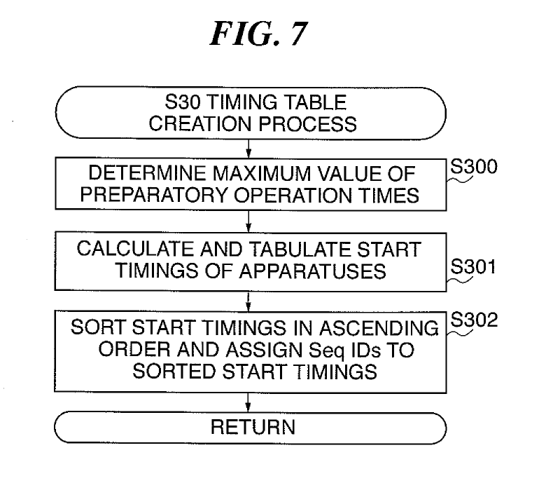

FIG. 7 is a flowchart showing the details of the timing table creation process (S30 in FIG. 6).

As shown in FIG. 7, the master controller 50 determines the maximum value of preparatory operation times of the slave controllers 51 to 53 indicated by data received in the preparatory operation time data reception process (A2) (step S300). Then, the master controller determines and tabulates differences between the maximum value determined in the step S300 and the preparatory operation times of the slave controllers 51 to 53 (step S301). The determined times are start-up commencement times (start timings) of the slave controllers. Then, the start timings are sorted in the ascending order and Seq IDs are assigned to the sorted start timings (step S302), and the process is returned.

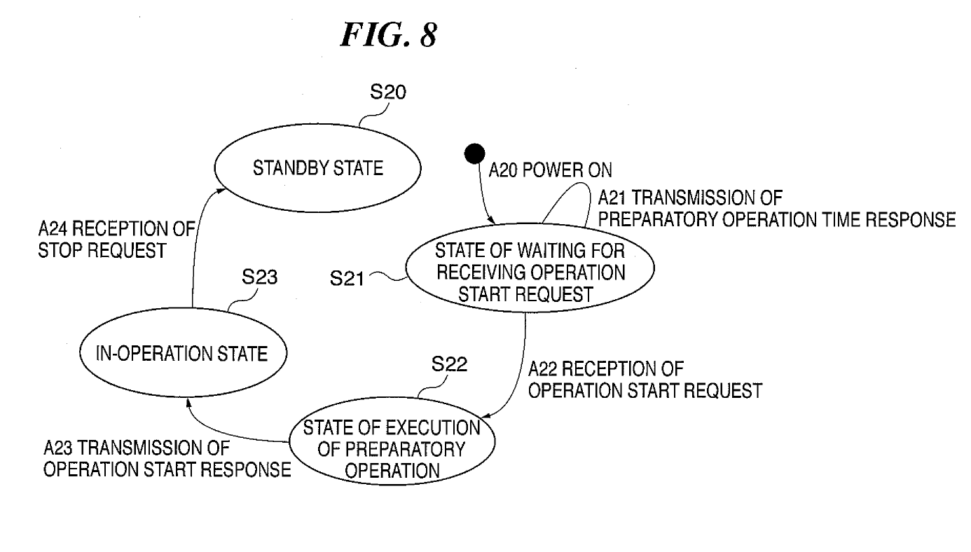

FIG. 8 is a state chart of the slave controller 51 appearing in FIG. 3. Since the slave controllers 51 to 53 are the same in operation, an explanation will be given of the slave controller 51.

As shown in FIG. 8, the slave controller 51 transmits to a state (S21) of waiting for receiving an operation start request when power is turned ON (A20). In the operation start request waiting state (S21), the slave controller calculates a preparatory operation time of the apparatus concerned, and transmits a preparatory operation time response to the master controller (A21).

When receiving an operation start request from the master controller 50 (A22), the slave controller 51 starts operating and transmits to a state (S22) of execution of preparatory operation. Upon completion of the preparatory operation of the apparatus, the slave controller transmits an operation start response to the master controller 50 and transmits to an in-operation state (S23) (A23). In the in-operation state (S23), the slave controller causes the apparatus to stop operating upon reception of a stop request from the master controller 50 (A24), and transmits to a standby state (S20).

Next, an explanation will be given of a process carried out by the slave controller of the glue apparatus 16 in the printer system 2 shown in FIG. 2.

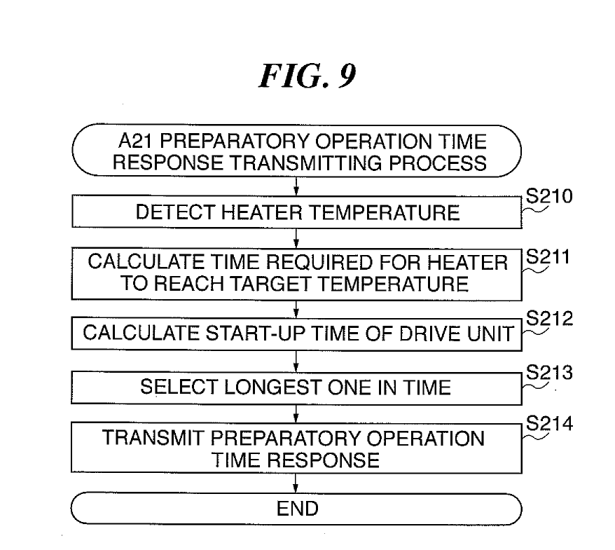

FIG. 9 is a flowchart showing a process for transmitting a preparatory operation time response appearing in FIG. 8. This process is executed by the slave controller 55 based on a program read out from a ROM or the like, not shown.

As shown in FIG. 9, when power is turned ON, the slave controller 55 transmits to the state (S21) of waiting for receiving an operation start request, in which a temperature of a heater to melt glue is detected (step S210) and calculates a heater temperature rise time required for the heater temperature to reach a predetermined temperature (step S211).

Next, the slave controller calculates a start-up commencement time, for example, to return a motor and a drive unit to their home positions (step S212), selects a longer one of the heater temperature rise time calculated in the step S211 and the start-up commencement time of the drive unit calculated in the step S212 (step S213), and transmits a preparatory operation time response to the master controller 50 (step S214). It should be noted that a method for calculating the preparatory operation time may be one other than the above described method as long as a time required for the apparatus concerned to complete the start-up can be notified to the master controller 50.

According to the first embodiment, when power of the apparatuses forming the printer system is turned ON, each of the slave controllers in the apparatuses calculates the preparatory operation time of the apparatus, and transmits data indicating the calculated preparatory operation time to the master controller. Based on the preparatory operation times indicated by the data received from the slave controllers, the master controller determines the start-up commencement times (start timings) of the slave controllers, and requests (instructs) the slave controllers to start operating after the elapse of the start-up commencement times. In response to the received operation start requests, the slave controllers cause preparatory operations to start. As a result, it is possible to reduce wasteful power consumption at the time when power is turned ON, prevent the service lives of the apparatuses from being shortened, and optimize the capacity of power source. The above described effects can be achieved even when apparatuses forming the printer system are added or altered.

### Second Embodiment

Next, a printer system according to a second embodiment will be explained. The printer system of the second embodiment is the same in construction as that of the above described first embodiment, and therefore an explanation on different points therebetween will be given below, with explanations on structural elements denoted by the same reference numerals omitted.

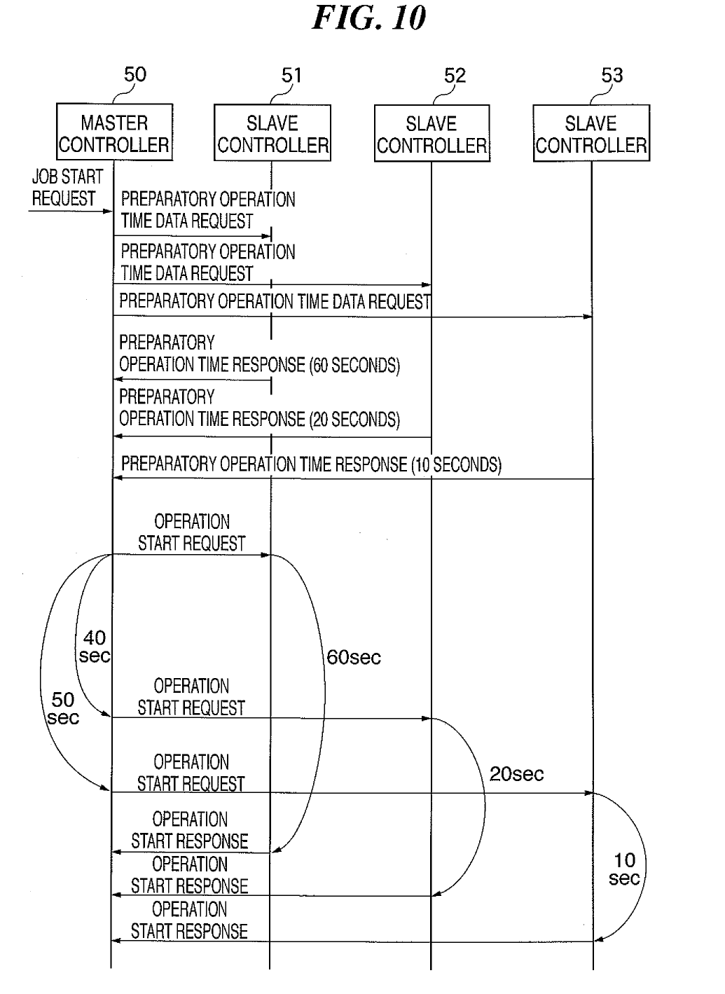

FIG. 10 is a sequence chart exemplarily showing communication between a master controller and a plurality of slave controllers in the printer system according to the second embodiment.

When power is turned on by a power switch, not shown, and a job start request is supplied from an operating panel, not shown, to the master controller 50 in the printer 10, the master controller 50 transmits operation preparation time requests to the slave controllers 51 to 53.

When receiving operation preparation time requests from the master controller 50, the slave controllers 51 to 53 start calculating preparatory operation times required for the apparatuses to complete preparatory operations. As in the case of the first embodiment, the preparatory operation times are calculated based on load arrangements of the apparatuses. Upon completion of the calculation of the preparatory operation times, the slave controllers 51 to 53 transmit, as preparatory operation time responses, data indicating the calculated preparatory operation times to the master controller 50.

When having received the preparatory operation time responses from the slave controllers 51 to 53, the master controller 50 performs a back calculation based on the longest preparatory operation time among the preparatory operation times indicated by the received data to create a timing table, such as one shown in the above described Table 1, for use for giving instructions to specify timings of starting operations of the slave controllers, and stores the timing table into a RAM, not shown, of the master controller 50.

When the timing table has been created, the master controller 50 sequentially transmits operation start requests to the slave controllers 51 to 53 with time differences determined based on the timing table. Specifically, the master controller 50 transmits the operation start request to the slave controller 52 upon elapse of 40 seconds after the operation start request is transmitted to the slave controller 51, and then transmits the operation start request to the slave controller 53 after elapse of further 10 seconds (upon elapse of 50 seconds after the operation start request is transmitted to the slave controller 51).

When receiving the operation start request, each of the slave controllers 51 to 53 causes the apparatus concerned to start its preparatory operation. When the preparatory operation is completed (upon completion of start-up), each of the slave controllers 51 to 53 transmits an operation start response to the master controller 50. The start-up completion timing of the entire printer system is made coincident with that of the controller which is the longest in preparatory operation time (the controller 51 in this embodiment), and when such timing is reached, the start-up of all the apparatuses is completed.

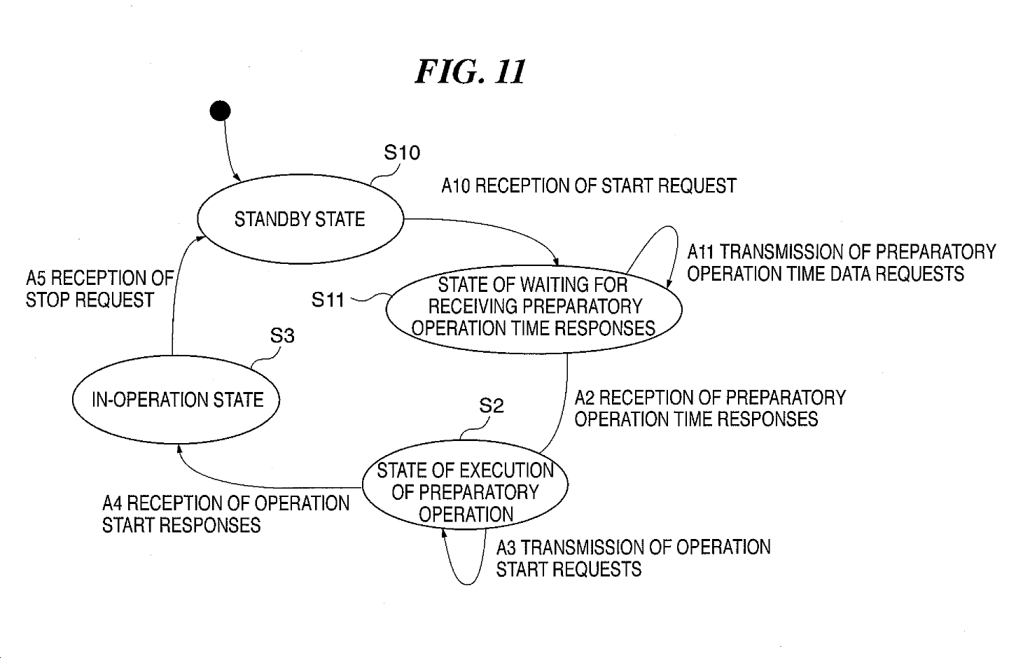

FIG. 11 is a state chart of the master controller 50 appearing in FIG. 10.

Referring to FIG. 11, when receiving a job start request (start request) in a standby state (S10), the master controller 50 transmits to a state (S11) of waiting for receiving preparatory operation time responses (A10). In the preparatory operation time response waiting state (S11), the master controller transmits preparatory operation time requests to the slave controllers 51 to 53 (A11). Upon reception of the preparatory operation time responses (preparatory operation time data) from the slave controllers 51 to 53 (A2), the master controller 50 transmits to a state (S2) of execution of preparatory operation.

In the preparatory operation execution state (S2), the master controller 50 creates a timing table based on preparatory operation times indicated by the received data, and transmits operation start requests to the apparatuses in sequence from the apparatus indicated at the top of the timing table (in Table 1, the first sheet feeder 11 having the apparatus ID of 51) (A3).

Next, the master controller 50 transmits to an in-operation state (S3) when having received operation start responses from the slave controllers 51 to 53 (A4). In the in-operation state (S3), the master controller 50 causes the slave controllers 51 to 53 to stop operating upon reception of a stop request (A5), whereupon the master controller transmits to a standby state (S10).

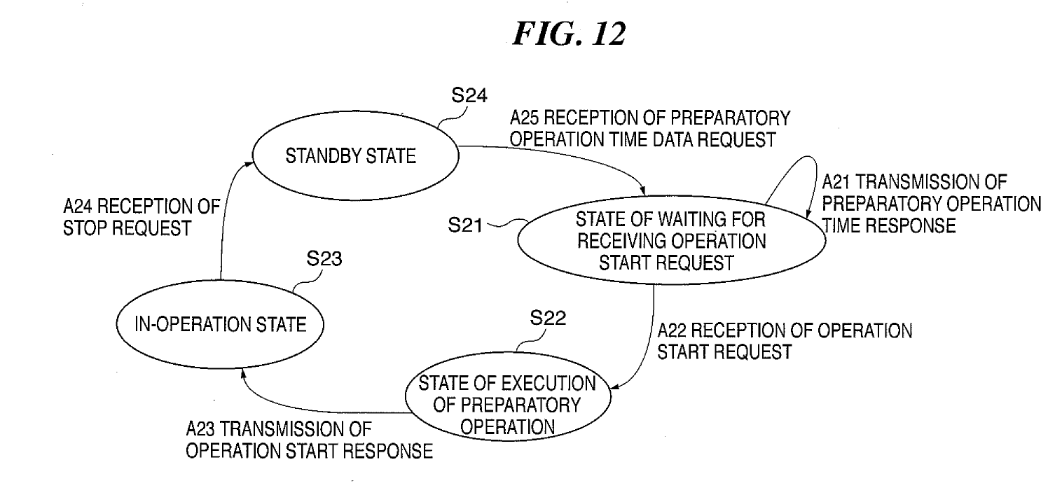

FIG. 12 is a state chart of the slave controller 51 appearing in FIG. 10. Since the slave controllers 51 to 53 are the same in operation, an explanation will be given of the slave controller 51.

Referring to FIG. 12, in a standby state (S24), when receiving a preparatory operation time request from the master controller 50 (A25), the slave controller 51 transmits to a state (S21) of waiting for receiving an operation start request. In the operation start request waiting state (S21), the slave controller calculates a preparatory operation time of the apparatus concerned, and transmits a preparatory operation time response to the master controller (A21).

When receiving an operation start request from the master controller 50 (A22), the slave controller 51 starts operating and transmits to a state (S22) of execution of preparatory operation. Upon completion of the preparatory operation of the apparatus (A23), the slave controller transmits an operation start response to the master controller 50 and transmits to an in-operation state (S23). In the in-operation state (S23), the slave controller causes the apparatus to stop operating upon reception of a stop request from the master controller 50 (A24), and transmits to a standby state (S24).

According to the second embodiment, when a job start request is given to the master controller, the master controller transmits preparatory operation time data requests to the slave controllers. In response to the preparatory operation time data request from the master controller, each of the slave controllers calculates a preparatory operation time of the apparatus concerned, and transmits data indicating the calculated preparatory operation time to the master controller. Based on the preparatory operation time data received from the slave controllers, the master controller determines start-up commencement times (start timings) of the slave controllers, and requests the slave controllers to start operating upon completion of the determined start-up times. In response to the operation start request, each of the slave controllers starts the preparatory operation. As a result, it is possible to reduce wasteful power consumption at start of a job, prevent the service lives of the apparatuses from being shortened, and optimize the capacity of power source. The above described effects can be achieved even when apparatuses forming the printer system are added or altered.

### Third Embodiment

Next, a printer system according to a third embodiment will be explained. The printer system of the third embodiment is the same in construction as that of the above described first embodiment. Thus, an explanation on different points will be given below, with explanations on structural elements denoted by the same reference numerals omitted.

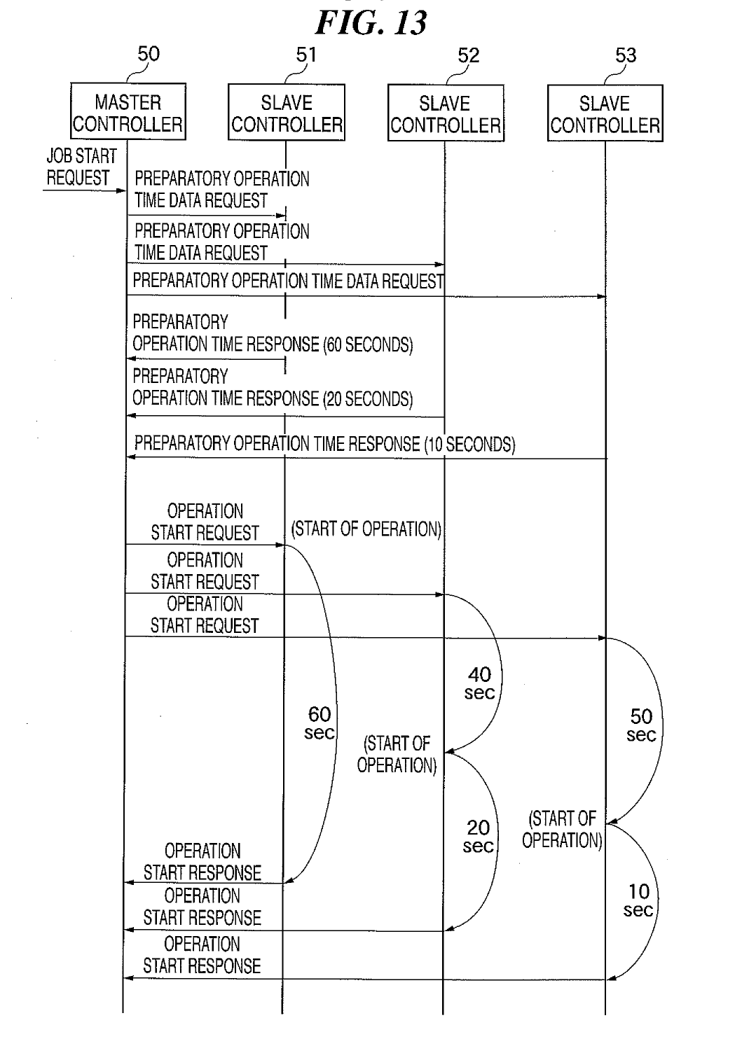

FIG. 13 is a sequence chart exemplarily showing communication between a master controller and a plurality of slave controllers in the printer system according to the third embodiment.

When power is on by a power switch, not shown, and a job start request is supplied from an operating panel, not shown, to the master controller 50 in the printer 10, the master controller 50 transmits operation preparation time requests to the slave controllers 51 to 53.

When receiving operation preparation time requests from the master controller 50, the slave controllers 51 to 53 start calculating preparatory operation times required for the apparatuses concerned to complete their preparatory operations. As in the case of the first embodiment, the preparatory operation times are calculated based on load arrangements of the apparatuses. Upon completion of the calculation of the preparatory operation times, the slave controllers 51 to 53 transmit, as preparatory operation time responses, data indicating the calculated preparatory operation times to the master controller 50.

When having received the preparatory operation time responses from the slave controllers 51 to 53, the master controller 50 performs a back calculation based on the longest preparatory operation time among the preparatory operation times indicated by the received data to create a timing table for use for giving instructions to specify timings of starting operations of the slave controllers, and stores the timing table into a RAM, not shown, of the master controller 50. An example of the created timing table is shown in the following Table 2.

TABLE 2

| Apparatus ID | Start-up Commencement Time (sec) |
|---|---|
| 51 | 0 |
| 52 | 40 |
| 50 | 45 |
| 53 | 50 |

In table 2, the apparatus ID is an ID for use for uniquely identifying each of the controllers connected to the network 5. For example, in a case where the preparatory operation times of the slave controllers 51 to 53 (having the apparatus IDs of 51 to 53) are respectively equal to 60 seconds, 20 seconds, and 10 seconds, then the timing table is created such as to permit all the apparatuses to complete their start-up processes upon elapse of the preparatory operation time of the slave controller 51, which is 60 seconds and is the longest among their preparatory operation times. Specifically, the master controller 50 determines the start-up commencement times (start timings) of the slave controllers 52, 53 so as to be 40 seconds behind and 50 seconds behind the referenced start-up commencement time of the slave controller 51. It should be noted that the controller 50 may calculate its own preparatory operation time and stores the calculated time in the timing table in a case where the master controller 50 (having the apparatus ID of 50) is required to start itself.

Based on the created timing table, the master controller 50 adds start-up commencement times, as timing data that instructs start timings of operations of the apparatuses, to operation start requests, and collectively transmits the operation start requests to the slave controllers 51 to 53.

When receiving the operation start requests from the master controller 50, the slave controllers 51 to 53 start timers in accordance with timing data added to the operation start requests. Each of the slave controllers starts a preparatory operation when the timer reaches the start-up commencement time indicated by the timing data. Specifically, the slave controllers 51 immediately starts the preparatory operation upon reception of the operation start request. The slave controllers 52 starts the preparatory operation upon elapse of 40 seconds after reception of the operation start request, and the slave controllers 53 starts the preparatory operation upon elapse of 50 seconds after reception of the operation start request.

When any of the preparatory operations has been completed (upon completion of start-up), a corresponding one of the slave controllers 51 to 53 transmits an operation start response to the master controller 50. A timing in which the start-up of the entire printer system is completed is made coincident with that of one controller which is the longest in preparatory operation time (in this embodiment, the slave controllers 51), and when such timing is reached, the start-up of the apparatuses is completed.

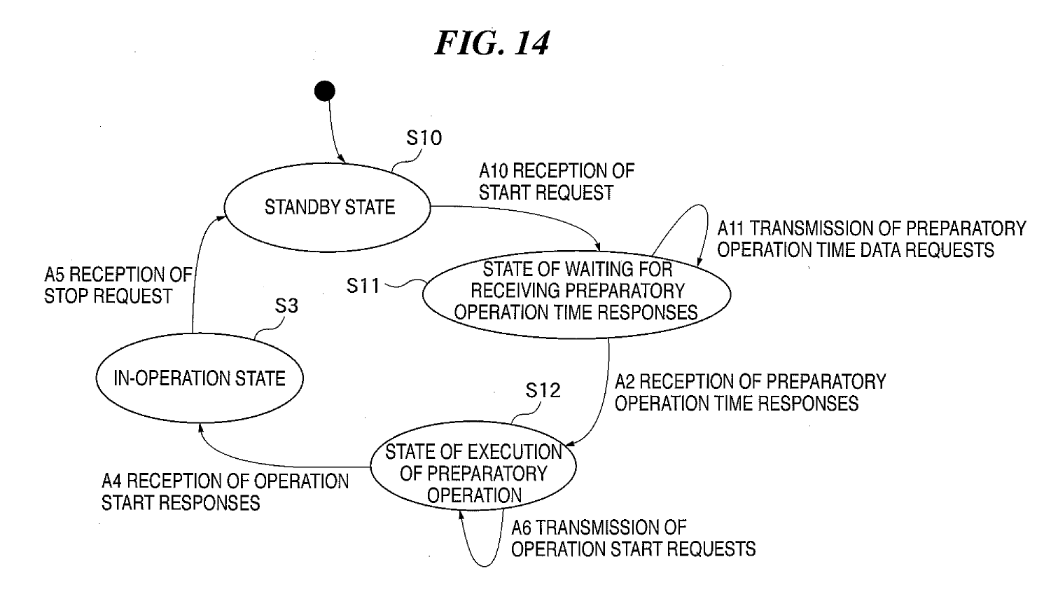

FIG. 14 is a state chart of the master controller 50 appearing in FIG. 13.

Referring to FIG. 14, when receiving a job start request (start request) (A10) in a standby state (S10), the master controller 50 transmits to a state (S11) for waiting preparatory operation time responses. In the preparatory operation time response waiting state (S11), the master controller transmits preparatory operation time data requests to the slave controllers 51 to 53 (A11). Upon reception of the preparatory operation time responses (preparatory operation time data) from the slave controllers 51 to 53 (A2), the master controller 50 transmits to a state (S12) of execution of preparatory operation.

In the preparatory operation execution state (S2), the master controller 50 creates a timing table based on the received preparatory operation time data, and transmits, to the slave controllers 51 to 53, operation start requests to each of which timing data based on the timing table is added (A6).

Next, the master controller 50 transmits to an in-operation state (S3) when having received operation start responses from the slave controllers 51 to 53 (A4). In the in-operation state (S3), the master controller 50 causes the slave controllers 51 to 53 to stop operating upon reception of a stop request (A5), whereupon the master controller transmits to a standby state (S10).

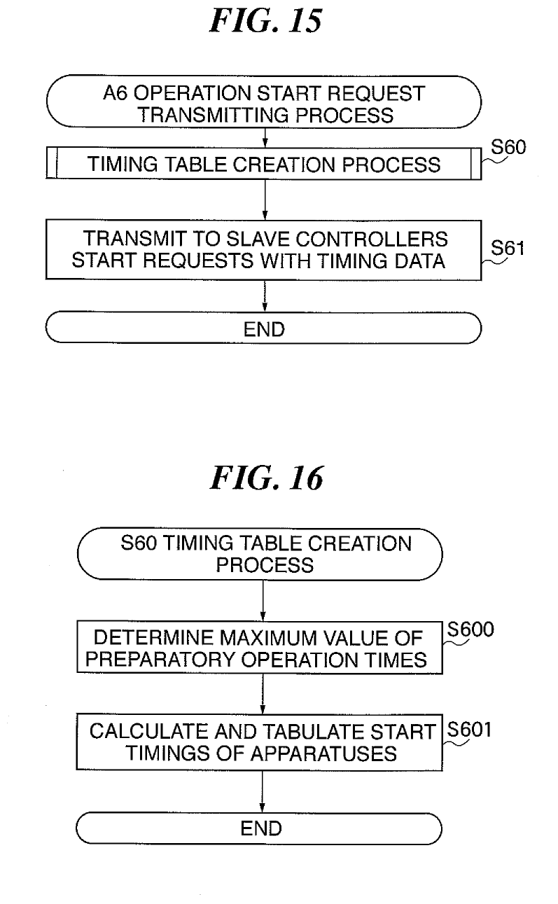

FIG. 15 is a flowchart showing a process for transmitting operation start requests (A6) appearing in FIG. 14. This process is executed by the master controller 50 based on a program read out from a ROM or the like, not shown.

As shown in FIG. 15, the master controller 50 carries out a process for creating a timing table based on preparatory operation time data received from the slave controllers 51 to 53 in the preparatory operation time data reception (A2) (step S60). Next, the master controller transmits, to the slave controllers corresponding to apparatus IDs, operation start requests to each of which timing data is added (step S61), whereupon the present process is completed.

FIG. 16 is a flowchart showing the details of the timing table creation process (S60 in FIG. 15).

As shown in FIG. 16, the master controller 50 determines the maximum value of preparatory operation times of the slave controllers 51 to 53 indicated by data received in the preparatory operation time data reception (A2) (step S600). Then, the master controller determines and tabulates differences between the maximum value determined in the step S600 and the preparatory operation times of the slave controllers 51 to 53 (step S601). The determined times are start-up commencement times (start timings) of the slave controllers.

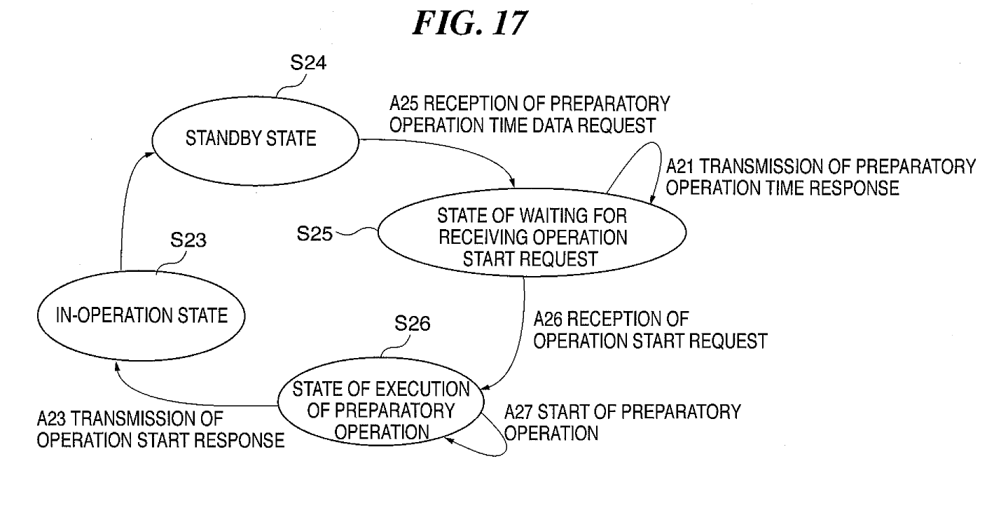

FIG. 17 is a state chart of the slave controller 51 appearing in FIG. 13. Since the slave controllers 51 to 53 are the same in operation, an explanation will be given of the slave controller 51.

As shown in FIG. 17, the slave controller 51 transmits to a state (S25) of waiting for receiving an operation start request when receiving, in a standby state (S24), a preparatory operation time data request from the master controller 50 (A25). In the operation start request waiting state (S25), the slave controller calculates a preparatory operation time of the apparatus concerned, and transmits a preparatory operation time response to the master controller (A21).

When receiving an operation start request from the master controller 50 (A26), the slave controller 51 sets timing data added to the operation start request to the timer and transmits to a state (S26) of execution of preparatory operation. When the timer set in A26 is up, the slave controller starts an preparatory operation (A27). Upon completion of the preparatory operation of the apparatus concerned, the slave controller transmits an operation start response to the master controller 50 (A23), and transmits to an in-operation state (S23). In the in-operation state (S23), the slave controller causes the apparatus to stop operating upon reception of a stop request from the master controller 50 (A24), and transmits to a standby state (S24).

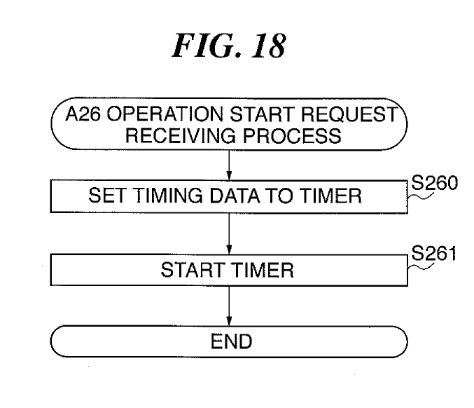

FIG. 18 is a flowchart showing a process for receiving an operation start request (A26) appearing in FIG. 17. This process is executed by the master controller 50 based on a program read out from a ROM or the like, not shown. A similar process is carried out for each of the slave controllers 52 to 55.

Referring to FIG. 18, the slave controllers 51 sets, to the timer, timing data added to the operation start request received from the master controller 50 (step S260), and starts the timer (step S261), whereupon the present process is completed.

According to the above described third embodiment, when a job start request is supplied to the master controller, the master controller transmits preparatory operation time data requests to the slave controllers. In response to the preparatory operation time data request from the master controller, each of the slave controller calculates a preparatory operation time of the apparatus concerned, and transmits data indicating the calculated preparatory operation time to the master controller. Based on the preparatory operation time data received from the slave controllers, the master controller determines start-up commencement times (start timings) of the slave controllers, and transmits to the slave controllers, as timing data, data indicating the start-up commencement times and added to the operation start requests. Each slave controller starts a preparatory operation based on the timing data added to the received operation start request. As a result, it is possible to reduce wasteful power consumption upon start of a job, prevent the service lives of the apparatuses from being shortened, and optimize the capacity of power source. It is also easy for the printer system to cope with addition or alteration of apparatuses forming the printer system.

### Forth Embodiment

Next, a printer system according to a fourth embodiment will be explained. Since the printer system of the fourth embodiment is the same in construction as that of the above described first embodiment, an explanation on different points will be given below, with explanations on structural elements denoted by the same reference numerals omitted.

In the fourth embodiment, the master controller 50 measures preparatory operation times of the slave controllers 51 to 53 and changes timings of operation start requests, in stead of exchanging preparatory operation times between the master controller 50 and the slave controllers 51 to 53.

When power is turned on by a power switch, not shown, and a job start request is supplied from an operating panel, not shown, to the master controller 50 in the printer 10, the master controller 50 transmits operation start requests to the slave controllers 51 to 53 and at the same time starts timers for measurement of times (preparatory operation times) required for the apparatuses to carry out preparatory operations.

When receiving an operation start request from the master controller 50, each of the slave controllers 51 to 53 starts a preparatory operation of the apparatus concerned. Each of the slave controllers 51 to 53 transmits an operation start response to the master controller 50 when the preparatory operation has been completed (upon completion of start-up).

When having received the operation start responses from the slave controllers 51 to 53, the master controller 50 refers to the timers to thereby record the preparatory operation times required for the preparatory operations. Then, the master controller 50 performs a back calculation based on the longest preparatory operation time among the preparatory operation times to create a timing table for use for giving instructions to specify timings of starting operations of the slave controllers, and stores the timing table into a RAM, not shown, of the master controller 50. An example of the created timing table is shown in the following Table 3.

TABLE 3

| Seq ID | Apparatus ID | Start-up Commencement Time (sec) |
|---|---|---|
| 1 | 51 | 0 |
| 2 | 52 | 40 |
| 3 | 50 | 45 |
| 4 | 53 | 50 |

In Table 3, the Seq IDs are IDs indicating the order in which the master controller 50 transmits operation start requests to respective ones of the slave controller 51 to 53, and the apparatus ID is an ID for use for uniquely identifying each of the controllers connected to the network 5. For example, in a case where the preparatory operation times of the slave controllers 51 to 53 (having the apparatus IDs of 51 to 53) are respectively equal to 60 seconds, 20 seconds, and 10 seconds, then the timing table is created such as to permit all the apparatuses to complete their start-up processes upon elapse of the preparatory operation time of the slave controller 51, which is 60 seconds and is the longest among their preparatory operation times. Specifically, the master controller 50 determines the start-up commencement times (start timings) of the slave controllers 52, 53 so as to be 40 seconds behind and 50 seconds behind the referenced start-up commencement time of the slave controller 51. It should be noted that the controller 50 may calculate its own preparatory operation time and stores the calculated time in the timing table in a case where the master controller 50 (having the apparatus ID of 50) is required to start itself.

At start of the next and subsequent operations, the master controller 50 sequentially transmits, to the slave controllers 51 to 53, the operation start requests with time differences determined based on the timing table. Specifically, the master controller 50 transmits the operation start request to the slave controller 52 upon elapse of 40 seconds after the operation start request is transmitted to the slave controller 51, and then transmits the operation start request to the slave controller 53 after elapse of further 10 seconds (upon elapse of 50 seconds after the operation start request is transmitted to the slave controller 51).

When receiving the operation start request, each of the slave controllers 51 to 53 causes the apparatus concerned to start a preparatory operation. When the preparatory operation is completed (upon completion of start-up), each of the slave controllers 51 to 53 transmits an operation start response to the master controller 50. The start-up completion timing of the entire printer system is made coincident with that of the controller which is the longest in preparatory operation time (the controller 51 in this embodiment), and when such timing is reached, the start-up of all the apparatuses is completed.

According to the above described fourth embodiment, when a job start request is instructed to the master controller, the master controller transmits operation start requests to the slave controllers and at the same time measures preparatory operation times of the apparatuses. When receiving an operation start request, each of the slave controller causes the apparatus concerned to start its preparatory operation, and transmits an operation start response to the master controller. The master controller 50 records preparatory operation times according to the received operation start responses, and based on the preparatory operation times, determines start-up commencement times (start timings) of the slave controllers. At start of the next operation, the master controller makes operation start requests (instructions) using the start timings. As a result, it is possible to reduce wasteful power consumption upon start of a job, prevent the service lives of the apparatuses from being shortened, and optimize the capacity of power source. It is also easy for the printer system to cope with addition or alteration of apparatuses forming the printer system.

Since the master controller transmits operation start requests to the slave controllers and measures operation preparation times according to operation start responses supplied from the slave controllers in response to the operation start requests, the aforementioned effects can be achieved even if there is any slave controller in the printer system that cannot supply a preparatory operation time response.

It is to be understood that the present invention may also be accomplished by supplying a system or an apparatus with a storage medium in which a program code of software, which realizes the functions of the above described embodiments is stored. In that case, a computer (or CPU or MPU) of the system or apparatus reads out and executes the program code stored in the storage medium. The program code itself read from the storage medium realizes the functions of the above described embodiments, and therefore the program code and the storage medium in which the program code is stored constitute the present invention.

Examples of the storage medium for supplying the program code include a floppy® disk, a hard disk, and a magnetic-optical disk. An optical disk such as a CD-ROM, a CD-R, a CD-RW, a DVD-ROM, a DVD-RAM, a DVD-RW, a DVD+RW, a magnetic tape, a nonvolatile memory card, and a ROM may also be employed. The program code may be downloaded via a network.

Further, it is to be understood that the functions of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

Further, it is to be understood that the functions of either of the above described embodiments may be accomplished not only by executing the program code read out by a computer, but also by causing an OS (operating system) or the like which operates on the computer to perform a part or all of the actual operations based on instructions of the program code.

In that case the program is supplied directly from a storage medium storing the program, or is downloaded via a network from another computer, a database, or the like, not shown, connected to the Internet, a commercial network, a local area network, or the like.

The present invention is not limited to a printer using the electrophotographic method, but is applicable to printing methods such as an ink jet method, a thermal transfer method, a thermography method, an electrostatic method, and a discharge breakdown method. The printer 10 in the above described printer system may be a multifunction peripheral, a facsimile machine or the like to which a sheet processing unit or another function device can be connected.

Needless to say, the above described printer system may be a system comprised of a computer and peripheral devices such as a printer, a scanner and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-163861, filed Jun. 13, 2006, which is hereby incorporated by reference herein in its entirety.

What is claimed is:

1. A printer system comprising:
a master apparatus including an image forming apparatus; and
at least two slave apparatuses connected for communication to said master apparatus via a network,
wherein said master apparatus includes:
a reception unit adapted to receive, from said at least two slave apparatuses, data indicating preparatory operation times required for said slave apparatuses to complete preparatory operations; and
an instruction unit adapted to give said slave apparatuses instructions to cause said slave apparatuses to start the operations based on the preparatory operation times indicated by the received data.

2. The printer system according to claim 1, wherein said instruction unit includes a timing table creation unit adapted to create a timing table for use for causing said slave apparatuses to start the operations based on the preparatory operation times indicated by the received data.

3. The printer system according to claim 2, wherein said instruction unit is adapted to give, in timings determined based on the timing table, said slave apparatuses the instructions to cause said slave apparatuses to start the operations.

4. The printer system according to claim 3, wherein said instruction unit is adapted to add, to the instructions to cause said slave apparatuses to start the operations, timing information for use for causing said slave apparatuses to start the operations in the timings determined based on the timing table.

5. The printer system according to claim 2, wherein said timing table creation unit is adapted to create the timing table based on a maximum value of the preparatory operation times indicated by the received data.

6. The printer system according to claim 1, wherein said at least two slave apparatuses each include a calculation unit adapted to start a calculation of the operation preparation times required for the slave apparatus to complete the preparatory operation when electric power is on.

7. A printer system comprising:
a master apparatus including an image forming apparatus; and
at least two slave apparatuses connected for communication with said master apparatus via a network,
wherein said master apparatus includes:
a request unit adapted to request said at least two slave apparatuses to send data indicating preparatory operation times required for said slave apparatuses to complete preparatory operations;
a reception unit adapted to receive the data indicating the preparatory operation times from said at least two slave apparatuses; and
an instruction unit adapted to give the slave apparatuses instructions to cause the slave apparatuses to start the operations based on the preparatory operation times indicated by the received data.

8. The printer system according to claim 7, wherein said instruction unit includes a timing table creation unit adapted to create a timing table for use for causing said slave apparatuses to start the operations based on the preparatory operation times indicated by the received data.

9. The printer system according to claim 8, wherein said instruction unit is adapted to give, in timings determined based on the timing table, said slave apparatuses the instructions to cause said slave apparatuses to start the operations.

10. The printer system according to claim 9, wherein said instruction unit is adapted to add, to the instructions to cause said slave apparatuses to start the operations, timing information for use for causing said slave apparatuses to start the operations in the timings determined based on the timing table.

11. The printer system according to claim 8, wherein said timing table creation unit is adapted to create the timing table based on a maximum value of the preparatory operation times indicated by the received data.

12. A printer system comprising:
a master apparatus including an image forming apparatus; and
at least two slave apparatuses connected for communication to said master apparatus via a network,
wherein each of said at least two slave apparatuses includes a calculation unit adapted to calculate a preparatory operation time required for the slave apparatus to complete a preparatory operation thereof, and a transmission unit adapted to transmit data indicating the calculated preparatory operation time to said master apparatus, and
wherein said master apparatus includes an instruction unit to give said at least two slave apparatuses instructions to cause the slave apparatuses to start the operations based on the preparatory operation times indicated by the data received from said slave apparatuses.

13. A printer system comprising:
a master apparatus including an image forming apparatus; and
at least two slave apparatuses connected for communication to said master apparatus via a network,
wherein said master apparatus includes:
a first instruction unit adapted to give said at least two slave apparatuses instructions to cause the slave apparatuses to start operations;
a reception unit adapted to receive responses indicating completions of preparatory operations from said at least two slave apparatuses;
a time measurement unit adapted to measure times from when said at least two slave apparatuses are given the instructions to cause the slave apparatuses to start the operations to when the responses are received; and
a second instruction unit to give said slave apparatuses instructions to cause the slave apparatuses to start the operations based on the measured times.

14. A control method of a printer system comprised of a master apparatus including an image forming apparatus and at least two slave apparatuses connected for communication to the master apparatus via a network, the control method comprising:
a reception step of receiving, from the at least two slave apparatuses, data indicating preparatory operation times required for the slave apparatuses to complete preparatory operations; and
an instruction step of giving the slave apparatuses instructions to cause the slave apparatuses to start operations based on the preparatory operation times indicated by the received data.

15. A control method of a printer system comprised of a master apparatus including an image forming apparatus and at least two slave apparatuses connected for communication to the master apparatus via a network, the control method comprising:
a request step of requesting the at least two slave apparatuses to send data indicating preparatory operation times required for the slave apparatuses to complete preparatory operations;
a reception step of receiving the data indicating the preparatory operation times from the at least two slave apparatuses; and
an instruction step of giving the slave apparatuses instructions to cause the slave apparatuses to start the operations based on the preparatory operation times indicated by the received data.

16. A control method of a printer system comprised of a master apparatus including an image forming apparatus and at least two slave apparatuses connected for communication to the master apparatus via a network, the control method comprising:
a calculation step of calculating preparatory operation times required for the slave apparatuses to complete preparatory operations thereof;
a transmission step of transmitting data indicating the calculated preparatory operation times to the master apparatus; and
an instruction step of giving the at least two slave apparatuses instructions to cause the slave apparatuses to start the operations based on the preparatory operation times indicated by the data received from the slave apparatuses.

17. A control method of a printer system comprised of a master apparatus including an image forming apparatus and at least two slave apparatuses connected for communication to the master apparatus via a network, the control method comprising:
a first instruction step of giving the at least two slave apparatuses instructions to cause the slave apparatuses to start operations;
a reception step of receiving responses indicating completions of preparatory operations from the at least two slave apparatuses;
a time measurement step of measuring times from when the at least two slave apparatuses are given the instructions to cause the slave apparatuses to start the operations to when the responses are received; and
a second instruction step of giving the slave apparatuses instructions to cause the slave apparatuses to start the operations based on the measured times.
